(19) United States
(12) Patent Application Publication
(10) Pub. No.: US 2026/0214522 A1
(43) Pub. Date: Jul. 23, 2026

(54) TERMINAL APPARATUS AND WIRELESS COMMUNICATION SYSTEM

(71) Applicant: KDDI CORPORATION, Tokyo (JP)

(72) Inventors: Jungyeon HONG, Fujimino-shi (JP); Hiroki TAKEDA, Fujimino-shi (JP); Takeo OHSEKI, Fujimino-shi (JP); Issei KANNO, Fujimino-shi (JP); Yanwei LI, Fujimino-shi (JP); Yoshitaka TAKAKU, Fujimino-shi (JP)

(21) Appl. No.: 19/577,866

(22) Filed: Mar. 25, 2026

Related U.S. Application Data
(63) Continuation of application No. PCT/JP2024/033902, filed on Sep. 24, 2024.

(30) Foreign Application Priority Data
Sep. 29, 2023 (JP) 2023-170293

(51) Int. Cl. H04W 36/00; H04W 72/21

(52) U.S. Cl. CPC H04W 36/0072; H04W 72/21

(57) ABSTRACT

A terminal apparatus obtains first information associating a configured grant regarding a resource of an uplink shared channel of an LTM candidate cell with an uplink beam setting, and information of a condition of LTM execution associated with the LTM candidate cell, transmits an uplink reference signal to a handover destination base station apparatus of the LTM candidate cell, obtains second information regarding an uplink beam determined by the LTM candidate cell based on a measurement result of the uplink reference signal, when the condition of LTM execution is satisfied, specifies a configured grant to be used for uplink transmission based on the first information and the second information, without starting a random access procedure, and performs uplink transmission to the base station apparatus of the handover destination candidate using this.

### CROSS-REFERENCE TO RELATED APPLICATION(S

This application is a continuation of International Patent Application No. PCT/JP2024/033902 filed on Sep. 24, 2024, which claims priority to and the benefit of Japanese Patent Application No. 2023-170293 filed on Sep. 29, 2023, the entire disclosures of which are incorporated herein by reference.

### BACKGROUND OF THE INVENTION

### Field of the Invention

The present invention relates to a terminal apparatus, and a wireless communication system.

### Description of the Related Art

In a mobile communication system, accompanying the movement of a terminal apparatus, a handover is performed to switch the cell (base station apparatus) to which the terminal apparatus connects. Conventionally, after receiving a handover instruction from a base station apparatus, a terminal apparatus performs processing to establish a connection by executing synchronization establishment and setting processing in the connection switching destination cell. This processing for switching the connection destination takes a certain amount of time, and during the period in which this processing is being performed, the terminal apparatus cannot communicate user data.

In contrast, in the method described in 3GPP (registered trademark) Contribution, R2-2209255, a handover source base station apparatus provides communication parameters in a Radio Resource Control (RRC) layer for connection with another base station apparatus which is a handover destination to a terminal apparatus before a handover is actually performed. Then, at the timing when the handover should be performed, the handover source base station apparatus transmits a Layer 1 or Layer 2 command instructing the switching of the cell to the terminal apparatus. In response to receiving the command, the terminal apparatus executes a random access procedure with the handover destination base station apparatus, thereby completing the handover without performing subsequent setting processing in the RRC layer. Such a cell switching technology is called LTM (L1L2 Triggered Mobility) and is considered to suppress deterioration of communication efficiency regarding handover.

In the handover processing by LTM disclosed in 3GPP (registered trademark) Contribution, R2-2209255, the terminal apparatus needs to receive a Cell Switch command from the base station apparatus.

However, if the Cell Switch Command cannot be received, the terminal apparatus cannot voluntarily activate the handover processing, and after detecting RLF (Radio Link Failure), must execute cell search processing and reconnection processing. For this reason, in the LTM technology of 3GPP (registered trademark) Contribution, R2-2209255, there exists a problem that the instantaneous interruption time of communication cannot be shortened, and the handover processing cannot be speeded up.

### SUMMARY OF THE INVENTION

In view of such a situation, the present disclosure proposes a technology that enables a terminal apparatus to execute LTM before receiving a Cell Switch command, thereby aiming for speeding up of handover processing and shortening of instantaneous interruption time.

In order to solve the above problem, the present disclosure proposes, as an example, a terminal apparatus that has a conditional LTM function and that performs communication with a plurality of base station apparatuses while switching a connection destination, comprising a storage device that holds a program related to handover; and a processor that reads the program from the storage device and executes handover processing, wherein the processor executes: obtaining, from a connected handover source base station apparatus, first information associating a configured grant regarding a resource of an uplink shared channel of an LTM candidate cell with an uplink beam setting, and information of a condition of LTM execution associated with a handover destination base station apparatus of the LTM candidate cell; transmitting an uplink reference signal to the handover destination base station apparatus of the LTM candidate cell in response to an uplink reference signal transmission instruction from the handover source base station apparatus; obtaining, from the handover source base station apparatus, second information regarding an uplink beam to be used by the terminal apparatus determined by the handover destination base station apparatus of the LTM candidate cell based on a measurement result of the uplink reference signal; determining whether the condition of LTM execution associated with the base station apparatus of the handover destination candidate is satisfied; specifying, when the condition of LTM execution is satisfied, a configured grant to be used for uplink transmission based on the first information and the second information at the time of LTM execution, without starting a random access procedure; and performing uplink transmission to the base station apparatus of the handover destination candidate using the configured grant to be used for the uplink transmission.

Further features of the present invention will become apparent from the following description of exemplary embodiments (with reference to the attached drawings).

### BRIEF DESCRIPTION OF THE DRAWINGS

The accompanying drawings, which are incorporated in and constitute a part of the specification, illustrate embodiments of the invention and, together with the description, serve to explain principles of the invention.

FIG. 1 is a diagram showing a schematic configuration example of a wireless communication system according to the present embodiment.

FIG. 2 is a diagram showing a schematic configuration example of a base station apparatus 100 according to the present embodiment.

FIG. 3 is a diagram showing a schematic configuration example of a terminal apparatus 200 according to the present embodiment.

FIG. 4 is a diagram for explaining a sequence example 1 of handover processing according to the present embodiment.

FIG. 5 is a diagram for explaining a sequence example 2 of handover processing according to the present embodiment.

FIG. 6 is a diagram for explaining a sequence example 3 of handover processing according to the present embodiment.

### DESCRIPTION OF THE EMBODIMENTS

Hereinafter, embodiments will be described in detail with reference to the attached drawings. Note, the following embodiments are not intended to limit the scope of the claimed invention, and limitation is not made to an invention that requires a combination of all features described in the embodiments. Two or more of the multiple features described in the embodiments may be combined as appropriate. Furthermore, the same reference numerals are given to the same or similar configurations, and redundant description thereof is omitted.

The present embodiment discloses executing LTM (however, RACH is not performed) to a candidate cell before a terminal apparatus receives a Cell Switch Command from a handover source base station apparatus. The technology according to this embodiment is not limited to this, but can be applied to, for example, wireless communication in frequency band FR2 (24.25 GHz to 52.6 GHz).

### Schematic Configuration Example of System

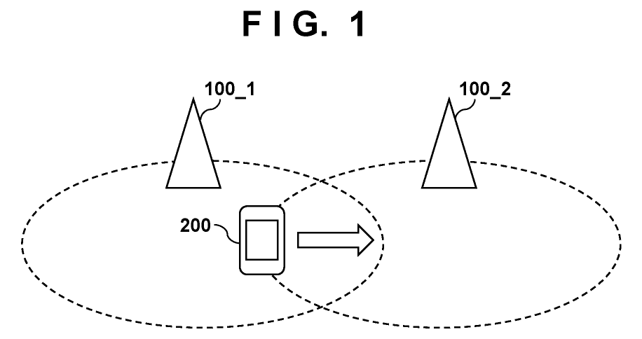

FIG. 1 is a diagram showing a schematic configuration example of a wireless communication system according to the present embodiment. The wireless communication system is a cellular communication system configured according to cellular communication standards such as the 5th Generation (5G) of the 3rd Generation Partnership Project (3GPP (registered trademark)) and successor standards thereof. The wireless communication system is configured to include a plurality of base station apparatuses (base station apparatus 100_1, base station apparatus 100_2, ...) and a terminal apparatus 200.

In FIG. 1, the terminal apparatus 200 is about to move from within the range of a cell formed by the base station apparatus (handover source base station apparatus) 100_1 into the range of a cell formed by the base station apparatus (handover destination base station apparatus) 100_2. At this time, the terminal apparatus 200 will perform a handover for switching the connected base station apparatus from the handover source base station apparatus 100_1 to the handover destination base station apparatus 100_2. Note that although only the handover destination base station apparatus 100_2 is shown as a handover destination candidate in FIG. 1, in reality, a plurality of handover destination candidates (handover destination base station apparatuses 100_3, 100_4, ..., 100_k, ...) may exist.

### Regarding Conditions (Events) of LTM Execution

In the LTM according to the present embodiment, the terminal apparatus 200 starts connection processing and cell switching processing with the handover destination base station apparatus 100_2 or other handover destination candidate base station apparatuses (handover destination base station apparatus 100_k: k=3, 4, ...) without receiving a command instructing cell switching (Cell switch command) from the handover source base station apparatus 100_1. As an example, after obtaining a condition (event) for starting cell switching processing and information regarding cell switching processing to be executed when determining a condition match from the handover source base station apparatus 100_1, the terminal apparatus 200 determines the condition match and executes cell switching processing according to the condition. For example, assume that cell switching processing to the handover destination base station apparatus 100_2 is associated with condition 1, and cell switching processing to another handover destination candidate base station apparatus (handover destination base station apparatus 100_3) is associated with condition 2. In this case, upon determining (confirming) a match of condition 1, the terminal apparatus 200 executes cell switching processing for switching to the base station apparatus 100_2. On the other hand, upon determining (confirming) a match of condition 2, the terminal apparatus 200 starts cell switching processing to the other handover destination candidate base station apparatus (handover destination base station apparatus 100_3). A plurality of pieces of information regarding the conditions and cell switching processing are included in a RRC Reconfiguration message of an RRC (Radio Resource Control) layer, and a condition set for each candidate cell is included in condExecutionCond. Also, communication parameters used for communication with the base station apparatus of the handover destination candidate are included in condLTMReconfig. These pieces of information are provided from the handover source base station apparatus 100_1 to the terminal apparatus 200.

### Specific Examples of Above Conditions (Events)

As conditions (events) of LTM execution, it is conceivable to set, for example, conditions related to wireless quality of a communicating cell or a candidate cell (CondEventA3, CondEventA4, CondEventA5, CondEventD1, CondEventT1). In this case, for example, RRC Reconfiguration includes information such as condReconfigId (condition setting identifier) = 1, condExecutionCond = condEventA4 (threshold = threshold 1), condLTMReconfig = communication parameters to candidate cell 1, condReconfigId = 2, condExecutionCond = condEventA4 (threshold = threshold 2), and condLTMReconfig = communication parameters to candidate cell 2, and this information is provided to the terminal apparatus 200.

Also, conventionally, it is conceivable that the base station apparatus 100 sets information (MeasId) for setting a report of event occurrence to the terminal apparatus 200 in condExecutionCond. Here, MeasId is associated with an identifier measObjectId used by the terminal apparatus to specify a measurement target of wireless quality, and an identifier reportConfigId used by the terminal apparatus to specify report timing to the base station apparatus. The identifier measObjectId is associated with a frequency of NR or LTE that the terminal apparatus 200 should make a measurement target. The identifier reportConfigId is associated with report timing to the base station apparatus 100, for example, an event of condEventA4 and a threshold related to that event. In this way, the terminal apparatus 200 can recognize a wireless quality event to be judged from MeasId set in condExecutionCond.

### Internal Configuration Example of Base Station Apparatus

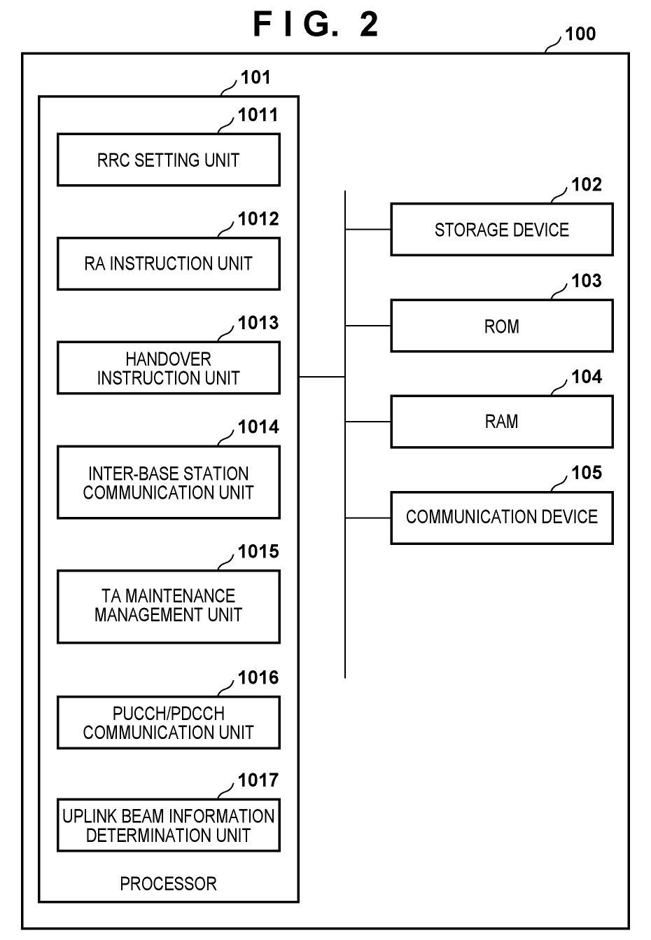

FIG. 2 is a diagram showing a schematic configuration example of the base station apparatus 100. The base station apparatus 100 comprises, for example, a processor 101, a storage device 102, a ROM (Read Only Memory) 103, a RAM (Random Access Memory) 104, and a communication device 105. The processor 101 is a computer configured to include one or more processing circuits such as a general-purpose CPU (Central Processing Unit) or an ASIC (Application Specific Integrated Circuit), and executes the overall processing of the apparatus or each process described above by reading and executing a program stored in the storage device 102 or the ROM 103. The ROM 103 is a read-only memory that stores information such as programs regarding processing executed by the base station apparatus 100 and various parameters. The RAM 104 is a random access memory that functions as a workspace when the processor 101 executes a program and also stores temporary information. The storage device 102 is configured by, for example, a detachable external storage device or the like. The communication device 105 is configured by, for example, a circuit for wireless communication of 5G or successor standards thereof. Although one communication device 105 is shown in FIG. 2, the base station apparatus 100 may comprise a plurality of communication devices. For example, the base station apparatus 100 has wireless communication devices for 5G and for successor standards thereof respectively, and an antenna common to those devices. Note that the base station apparatus 100 may separately have an antenna suitable for each standard. Also, the base station apparatus 100 may further have a wired communication device used when communicating with other base station apparatuses or nodes of a core network. The base station apparatus 100 may have a separate communication device 105 for each of a plurality of usable frequency bands, or may have a common communication device 105 for at least a part of those frequency bands.

The processor 101 generates an RRC setting unit 1011, an RA instruction unit 1012, a handover instruction unit 1013, an inter-base station communication unit 1014, a TA maintenance management unit 1015, a PUCCH/PDCCH communication unit 1016, and an uplink beam information determination unit 1017 by reading a program regarding handover stored in the storage device 102 or the ROM 103 and deploying it in an internal memory (not shown).

FIG. 2 shows only functions particularly related to the present embodiment, and illustration of other various functions that the base station apparatus 100 can have is omitted. For example, the base station apparatus 100 naturally has other functions generally possessed by base station apparatuses compliant with 5G or successor standards thereof. Furthermore, the functional blocks in FIG. 2 are shown schematically, and respective functional blocks may be realized integrally or may be further subdivided. Also, each function in FIG. 2 may be realized by, for example, the processor 101 executing a program stored in the ROM 103 or the storage device 102, or may be realized by, for example, a processor existing inside the communication device 105 executing predetermined software. Note that regarding details of processing executed by each functional unit, the details described above will not be described here, and only rough functions thereof will be outlined. Also, in the following, an operation outline in a system configured by the handover source base station apparatus 100_1, one handover destination base station apparatus 100_2 which is an LTM transition destination candidate, and the terminal apparatus 200 is described; however, when there are a plurality of LTM transition destination candidates, the handover source base station apparatus 100_1 and the terminal apparatus 200 execute similar operations with each candidate handover destination base station apparatus 100_k.

The RRC setting unit 1011 of the handover source base station apparatus 100_1 performs setting of the RRC layer for, for example, the connected terminal apparatus 200. The RRC setting unit 1011 transmits a handover request to another base station apparatus 100 (handover destination base station apparatus 100_2, handover destination base station apparatus 100_3, etc.) that is a candidate for a handover destination providing an adjacent cell, obtains communication setting information (communication parameters) therefrom, and notifies the terminal apparatus 200 of the communication setting information and the above condition of LTM execution (communication parameters and LTM execution condition of each candidate cell) by an RRC layer message. Also, in this case, the aforementioned communication setting information (communication parameters) also includes information required when the terminal apparatus 200 executes a random access procedure (a sequence for RA preamble generation, information on wireless resources used for transmission of RA preamble, etc.). In the present embodiment, the message of the RRC layer is an RRC Configuration message. Then, the RRC setting unit 1011 performs setting for processing for connection between the terminal apparatus 200 and the other base station apparatus 100 (handover destination base station apparatus 100_2) upon receiving an RRC Configuration Complete message from the terminal apparatus 200.

The RA instruction unit 1012 instructs the terminal apparatus 200 for which the RRC layer setting has been completed to transmit an RA preamble to the other base station apparatus 100 (handover destination base station apparatus 100_2) that is a handover destination candidate. Here, the RA preamble transmission instruction includes a sequence for RA preamble generation unique to the terminal apparatus 200 or a group of sequences usable also by other terminal apparatuses 200 trying to connect to the other base station apparatus 100, and also includes information on wireless resources used for transmission of the RA preamble. The RA instruction unit 1012 can instruct the connected terminal apparatus 200 to transmit the RA preamble to the handover destination (candidate) base station apparatus 100_2 by, for example, a Physical Downlink Control Channel (PDCCH) order. Also, the RA instruction unit 1012 instructs the terminal apparatus 200 to retransmit the RA preamble as necessary, or, when configured such that the RA preamble is repeatedly transmitted, can transmit an RA preamble transmission stop instruction to the terminal apparatus 200.

The handover instruction unit 1013 of the handover source base station apparatus 100_1 gives an instruction for causing the terminal apparatus 200 to execute a handover. The handover instruction unit 1013 of the handover source base station apparatus 100_1 notifies (transfers) the TA value thereof obtained from the handover destination base station apparatus 100_2 (obtained by the inter-base station communication unit 1014 as described later) to the terminal apparatus 200 before transmission of the Cell Switch Command.

Also, the handover instruction unit 1013 of the handover source base station apparatus 100_1 notifies the terminal apparatus 200 of a TCI (Transmission Configuration Indicator) designated based on a measurement result obtained by the handover destination base station apparatus 100_2 measuring a sounding reference signal (SRS) directly transmitted from the terminal apparatus 200. Here, the TCI is information designating an uplink beam (UL Beam) to be used by the terminal apparatus 200.

Furthermore, the handover instruction unit 1013 of the handover source base station apparatus 100_1 transmits to the terminal apparatus 200 a Cell switch command including information such as a cell identifier capable of identifying the handover destination base station apparatus 100_2, for example.

The inter-base station communication unit 1014 of the base station apparatus 100_1 performs communication with each handover destination candidate base station apparatus (handover destination base station apparatus 100_2, 100_3, etc.) (for example, communication via a dedicated wired line). The inter-base station communication unit 1014 can notify, for example, the handover destination base station apparatus 100_2, which is the transmission destination of the RA preamble, that the connected terminal apparatus 200 is to be made to transmit an RA preamble. Also, the inter-base station communication unit 1014 is used, for example, to receive information for an RA procedure in the handover destination candidate base station apparatus (handover destination base station apparatus 100_2). Also, the inter-base station communication unit 1014 can receive, for example, a message (message 2 or message 4) to be transmitted from the handover destination base station apparatus 100_2 to the terminal apparatus 200 in the RA procedure. Furthermore, the handover source base station 100_1 can obtain the TA value calculated in the handover destination base station apparatus 100_2 via the inter-base station communication unit 1014. Note that the signal received in the inter-base station communication unit 1014 is transferred to the terminal apparatus 200 via, for example, the RA instruction unit 1012. Also, the inter-base station communication unit 1014 of the handover source base station apparatus 100_1 obtains uplink beam (UL Beam) information (described later) to be used by the terminal apparatus 200, notified from the handover destination base station apparatus 100_2.

The TA maintenance management unit 1015 of the handover source base station 100_1 manages a TA value to be used when the terminal apparatus 200 transmits an uplink signal to the handover destination base station apparatus 100_2. The TA maintenance management unit 1015 sets, for example, an expiration time or an update cycle of the TA value, and can instruct, for example, the terminal apparatus 200 to retransmit the RA preamble so that the TA value is updated when the expiration time has elapsed or when the update cycle arrives. Also, the TA maintenance management unit 1015 may update the TA value by notifying the terminal apparatus 200 of an SRS setting in the handover destination base station apparatus 100_2 and causing the terminal apparatus 200 to transmit an SRS using the SRS setting. Note that the terminal apparatus 200 may obtain the TA value via the TA maintenance management unit 1015 of the handover destination base station apparatus 100_2. In this case, the base station apparatus 100_2 can transmit a transmission instruction of the RA preamble or a transmission instruction of the SRS to the terminal apparatus 200.

The PUCCH/PDCCH communication unit 1016 operates, for example, when the base station apparatus 100 is the handover destination base station apparatus 100_2. As described above, when the handover destination base station apparatus 100_2 notifies the TA value to the handover source base station apparatus 100_1, the handover destination base station apparatus 100_2 can start reception of PUCCH and transmission of PDCCH with the terminal apparatus 200.

For example, when the base station apparatus 100 is the handover destination base station apparatus 100_2, the uplink beam information determination unit 1017 measures the uplink reference signal (SRS) transmitted by the terminal apparatus 200, and specifies uplink beam (UL Beam) information to be used by the terminal apparatus 200 based on the measurement result.

Also, for example, when the base station apparatus 100 is the handover destination base station apparatus 100_2, the uplink beam information determination unit 1017 may obtain a measurement result of a downlink reference signal from the handover destination base station apparatus 100_2 measured by the terminal apparatus 200 from the handover source base station apparatus 100_1, and specify beam (UL Beam) information to be used by the terminal apparatus 200 based on the measurement result.

### Internal Configuration Example of Terminal Apparatus

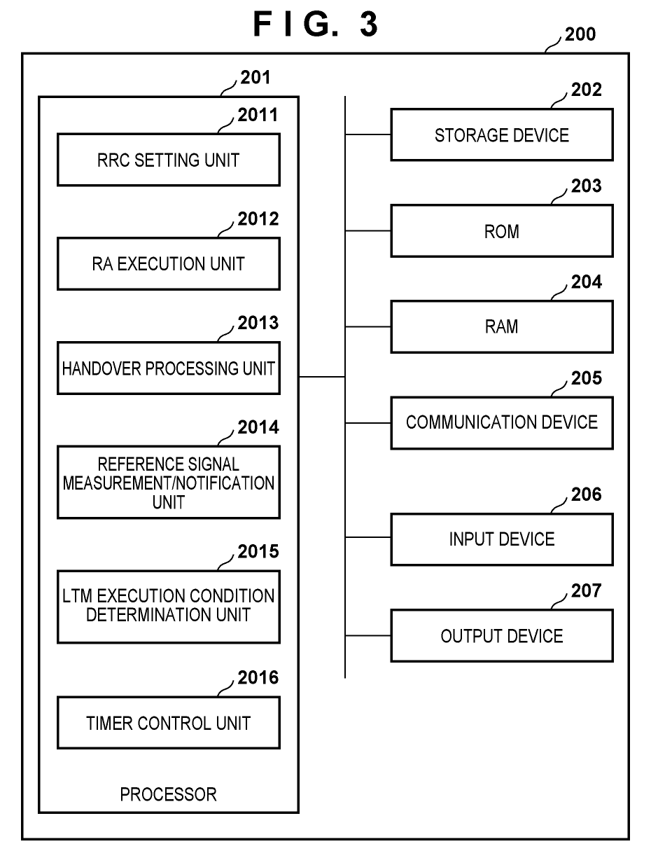

FIG. 3 is a diagram showing a schematic configuration example of the terminal apparatus 200. The terminal apparatus 200 comprises, for example, a processor 201, a storage device 202, a ROM (Read Only Memory) 203, a RAM (Random Access Memory) 204, a communication device 205, an input device 206, and an output device 207. The processor 201 is a computer configured to include one or more processing circuits such as a general-purpose CPU (Central Processing Unit) or an ASIC (Application Specific Integrated Circuit), and executes the overall processing of the apparatus or each process described above by reading and executing a program stored in the storage device 202 or the ROM 203. The ROM 203 is a read-only memory that stores information such as programs regarding processing executed by the terminal apparatus 200 and various parameters. The RAM 204 is a random access memory that functions as a workspace when the processor 201 executes a program and also stores temporary information. The storage device 202 is configured by, for example, a detachable external storage device or the like. The communication device 205 is configured by, for example, a circuit for wireless communication of 5G or successor standards thereof. Although one communication device 205 is shown in FIG. 3, the terminal apparatus 200 may comprise a plurality of communication devices. For example, the terminal apparatus 200 has wireless communication devices for 5G and for successor standards thereof respectively, and an antenna common to those devices. Also, the terminal apparatus 200 may have a communication device compliant with a wireless communication standard other than cellular communication standards, such as a wireless local area network (LAN) or Bluetooth (registered trademark). Furthermore, the terminal apparatus 200 may separately have an antenna suitable for each standard. Also, the terminal apparatus 200 may have a separate communication device 205 for each of a plurality of usable frequency bands, or may have a common communication device 205 for at least a part of those frequency bands.

The input device 206 can be configured by, for example, a touch panel, a numeric keypad, or the like, and is used when a user performs a predetermined operation or inputs desired information. The output device 207 can be configured by, for example, a display device, and displays information indicating a communication status, information indicating success or failure of a handover, or the like in relation to the present embodiment.

The processor 201 generates an RRC setting unit 2011, an RA (Random Access) execution unit 2012, an LTM execution condition determination unit 2015, a handover processing unit 2013, a timer control unit 2016, and a reference signal measurement/notification unit 2014 by reading a program regarding handover stored in the storage device 202 or the ROM 203 and deploying it in an internal memory (not shown). Note that FIG. 3 shows only functions particularly related to the present embodiment, and illustration of other various functions that the terminal apparatus 200 can have is omitted. For example, the terminal apparatus 200 naturally has other functions generally possessed by terminal apparatuses compliant with 5G or successor standards thereof. Also, the functional blocks in FIG. 3 are shown schematically, and respective functional blocks may be realized integrally or may be further subdivided.

The RRC setting unit 2011 performs processing for setting a connection with the handover destination (candidate) base station apparatus 100_2 upon receiving an RRC layer message from the connected handover source base station apparatus 100_1. Note that the RRC setting unit 2011 holds settings of the connected handover source base station apparatus 100_1 and settings of a plurality of handover destination candidate base station apparatuses (handover destination base station apparatus 100_k: k=2, 3, 4, ..., n) in parallel.

The RA execution unit 2012 receives an RA preamble transmission instruction from the handover source base station apparatus 100_1. The RA preamble transmission instruction is performed by a PDCCH order. Note that the RA execution unit 2012 can also receive, for example, an RA preamble retransmission instruction, an RA preamble transmission stop instruction, and the like. Also, the RA execution unit 2012 transmits an RA preamble to the handover destination (candidate 1) base station apparatus 100_2 in response to the reception of the RA preamble transmission instruction. Here, a sequence for generation of the RA preamble and information on wireless resources for reception of the RA preamble in the handover destination base station apparatus (candidate 1) 100_2 are obtained from the connected handover source base station apparatus 100_1. Note that the information on the sequence and wireless resources may be obtained from system information sent out by the handover destination base station apparatus 100_2.

Upon obtaining the TA value of the handover destination base station apparatus 100_2 and an uplink reference signal (SRS) transmission instruction from the handover source base station apparatus 100_1 (for example, received by MAC CE, Downlink Control Information (DCI), or RAR), the handover processing unit 2013 transmits an uplink reference signal (SRS) directly to the handover destination (candidate 1) base station apparatus 100_2. As described above, the handover destination base station apparatus 100_2 measures the SRS, determines a TCI (Transmission Configuration Indicator) based on the measurement result, and notifies the handover source base station apparatus 100_1 of this. Furthermore, the handover processing unit 2013 receives the TCI (beam information) from the handover source base station apparatus 100_1 using MAC CE or Physical Downlink Control Channel (PDCCH)/Downlink Control Information (DCI). Note that beam information is information specifying a TCI state or spatial relationship (information indicating a relationship between a UL beam and a DL beam, used when TCI state is not supported).

Also, the handover processing unit 2013 changes the connection destination to the handover destination base station apparatus 100_2 in response to reception of a Cell Switch command from the connected handover source base station apparatus 100_1. When allocation of an uplink wireless resource in the handover destination base station apparatus 100_2 is notified in the received Cell Switch command, the terminal apparatus 200 can immediately transmit an uplink signal using the wireless resource.

The reference signal measurement/notification unit 2014 measures a downlink reference signal from the handover destination base station apparatus 100_2 (one of the LTM transition destination candidate cells), and notifies the handover source base station apparatus 100_1 of a measurement result. When there are a plurality of LTM transition destination candidate cells, it measures downlink reference signals from all corresponding handover destination base station apparatuses 100_k, and notifies the handover source base station apparatus 100_1 of each measurement result.

On the other hand, the LTM execution condition determination unit 2015 determines whether conditions of LTM execution associated with the plurality of candidate cells notified from the handover source base station apparatus 100_1 are satisfied. A handover destination to be executed is uniquely determined by a condition match. For example, conditions of LTM execution are decided such that a threshold included in communication parameters is set low for a candidate cell with good communication status (not congested), and a threshold is set high for a candidate cell with poor communication status (congested).

When a match of the above condition of LTM execution is determined (confirmed) by the LTM execution condition determination unit 2015, the handover processing unit 2013 executes handover processing not including RA execution processing for the candidate cell (handover destination base station apparatus 100_k) satisfying the condition (details will be described later). For example, when it is determined that the condition of LTM execution associated with the handover destination base station apparatus 100_2 of candidate 1 is satisfied, the handover processing unit 2013 can voluntarily execute handover processing even if the Cell Switch Command cannot be received, in the same way as when it could be received. For this reason, it is not necessary to execute reconnection processing starting from cell search, and cell switching can be performed rapidly.

When it is determined by the LTM execution condition determination unit 2015 that the communication status matches the above condition of LTM execution, the handover processing unit 2013 specifies a configured grant to be used for uplink transmission according to the obtained uplink beam information at a timing based on the above TA value, and transmits uplink data, for example, RRCReconfiguration Complete, to the handover destination base station apparatus 100_2 using a resource (PUSCH) of an uplink shared channel corresponding to the configured grant. Then, the handover processing unit 2013 receives a UE Contention Resolution Identity MAC CE or C-RNTI addressed PDCCH from the handover destination base station apparatus 100_2.

The timer control unit 2016 controls activation and stop of various timers (T304, etc.). For example, the timer (T304) is activated triggered by confirmation of the above LTM execution condition match and decision to execute LTM, and stops when receiving UE Contention Resolution Identity MAC CE or C-RNTI addressed PDCCH from the connection destination base station apparatus 100.

### Operation at RLF Detection

As described above, regarding the condition of LTM execution designated from the handover source base station apparatus 100_1, when the terminal apparatus 200 determines (confirms) the condition match, it starts cell switching processing. On the other hand, when detecting RLF (Radio Link Failure), the terminal apparatus 200 may start cell switching processing even if the condition is not matched.

When providing information (communication parameters) regarding the condition of LTM execution and cell switching processing associated with the condition for each candidate cell to the terminal apparatus 200, the handover source base station apparatus 100_1 additionally provides information of attemptCondReconfig=True/False. When detecting RLF (Radio Link Failure), the terminal apparatus 200 searches for and selects a cell to be used for communication. When attemptCondReconfig notified together with the information regarding the cell switching processing is True, the terminal apparatus 200 determines whether or not the cell selected after the search is a base station apparatus of a handover destination candidate (handover destination base station apparatus 100_k) designated in the cell switching processing. If determining that it is not a base station apparatus of a handover destination designated in the cell switching processing, the terminal apparatus 200 executes reconnection processing as conventionally. If it is a base station apparatus of a handover destination designated in the cell switching processing (any of the notified candidate cells), it starts cell switching processing even if the condition is not matched. Thereby, the instantaneous interruption time can be shortened. Also in this case, if the cell selected after the search is a base station apparatus of a handover destination candidate designated in the cell switching processing, that is, an LTM candidate cell, a configured grant (uplink resource and uplink beam information) corresponding to the selected downlink reference signal is specified based on wireless quality of a downlink reference signal (SSB or CSI-RS) of the LTM candidate cell and a UL Beam information table described later, and can be used for uplink transmission at the time of LTM execution. Also, if uplink beam information regarding the selected cell has been received before RLF detection, it is also conceivable to specify a configured grant to be used for uplink transmission from information of the uplink beam received from the base station apparatus, instead of wireless quality of the downlink reference signal (SSB or CSI-RS) of the LTM candidate cell, and use it for uplink transmission at the time of LTM execution.

### Handover Processing Sequence Example 1

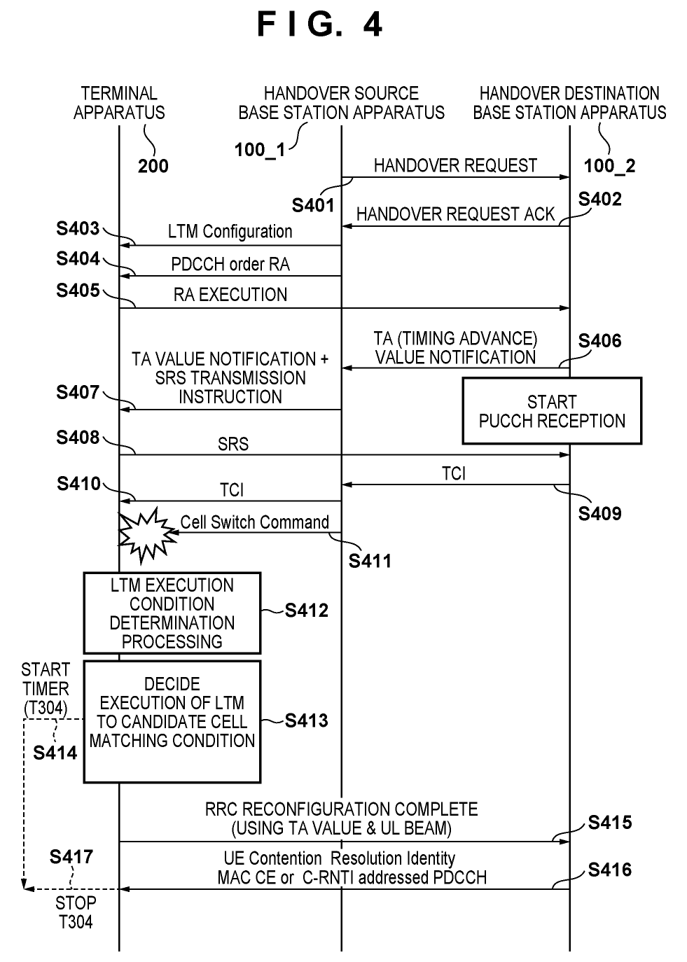

FIG. 4 is a diagram for explaining a sequence example 1 of handover processing according to the present embodiment. The sequence shown in FIG. 4 is an example, and variations as described above can be made in each procedure. For example, FIG. 4 shows an example in which a unique sequence is notified to the terminal apparatus 200 as a sequence for generation of an RA preamble to be transmitted to the handover destination base station apparatus 100_2, but it may be replaced with the above-described procedure in which a group of sequences usable by a plurality of terminal apparatuses 200 is notified. Note that in the example of FIG. 4, it is assumed that a connection is established between the handover source base station apparatus 100_1 and the terminal apparatus 200. Also, in FIG. 4, only the handover destination base station apparatus 100_2 is shown as a base station apparatus of an LTM transition destination candidate cell, but in reality, there exist handover destination base station apparatuses 100_k of a plurality of LTM transition destination candidate cells.

In each step, the operating subject is each processing unit (RRC setting unit 1011, etc.), but since each processing unit is a function realized by the processor 101 or 201 of the base station apparatus 100 or the terminal apparatus 200, the processor 101 or 201 may be the operating subject. In the following description, processing units of the handover source base station apparatus 100_1 are respectively denoted as RRC setting unit 1011_1, RA instruction unit 1012_1, handover instruction unit 1013_1, inter-base station communication unit 1014_1, TA maintenance management unit 1015_1, and PUCCH/PDCCH communication unit 1016_1. Also, processing units of the handover destination base station apparatus 100_2 are respectively denoted as RRC setting unit 1011_2, RA instruction unit 1012_2, handover instruction unit 1013_2, inter-base station communication unit 1014_2, TA maintenance management unit 1015_2, PUCCH/PDCCH communication unit 1016_2. Furthermore, in each of the following steps, various communications are actually executed by each processing unit of the base station apparatus and the terminal apparatus controlling the communication device 105 or the communication device 205.

### (i) Step S401

The inter-base station communication unit 1014_1 of the handover source base station apparatus 100_1 transmits a HANDOVER REQUEST message to the inter-base station communication unit 1014_2 of the handover destination base station apparatus 100_2 forming an adjacent cell, which is a handover destination candidate of the terminal apparatus 200, or to other base station apparatuses (other candidate cells: inter-base station communication unit 1014_k (k=3, 4, ...) of handover destination base station apparatus 100_k).

### (ii) Step S402

Upon receiving the HANDOVER REQUEST message, the inter-base station communication unit 1014_2 of the handover destination (candidate 1) base station apparatus 100_2 returns a HANDOVER REQUEST ACK message including information of communication parameters to be used when the terminal apparatus 200 connects, etc., to the handover source base station apparatus 100_1. The communication parameters include CG (configured grant) setting information including information such as beam settings, parameters when executing an RA (random access) procedure, and wireless resources (frequency and time resources) to be used in the handover destination base station apparatus 100_2. Other candidate cell base station apparatuses similarly provide communication parameters to the handover source base station apparatus 100_1.

### (iii) Step S403

The RRC setting unit 1011_1 of the handover source base station apparatus 100_1 notifies, to the terminal apparatus 200, an LTM Configuration message including the above communication parameters etc. obtained from the handover destination base station apparatus 100_2. Also, at this time, the RRC setting unit 1011_1 provides the terminal apparatus 200 with a condition (event: condition of LTM execution) enabling execution of LTM before the terminal apparatus 200 receives the Cell Switch Command. By this processing, the terminal apparatus 200 does not need to perform RRC layer setting processing after being instructed regarding a handover to the handover destination base station apparatus 100_2 from the RA instruction unit 1012_1. Note that when there are a plurality of handover destination (candidate) base station apparatuses, similar setting processing is executed for each.

The RRC setting unit 2011 of the terminal apparatus 200 receives information (UL Beam information table) associating information of a synchronization signal (SS)/physical broadcast channel (PBCH) block (SSB: Synchronization Signal Block) (information of downlink reference signal: for example, SSB index), CG (Configured grant) setting information (CG occasion) regarding uplink resources, and uplink beam information (TCI), transmitted from a base station apparatus of each LTM transition destination candidate cell (for example, handover destination base station apparatus 100_2), by LTM Configuration included in the RRC Reconfiguration message.

For example, when receiving TCI=1 from the handover destination base station apparatus 100_2 via the handover base station apparatus 100_1, the terminal apparatus 200 performs uplink transmission to the handover destination base station apparatus 100_2 after LTM execution using an uplink resource and uplink beam information (configured grant) corresponding to SSB index=1 and the 1st CG setting information (CG Occasion) associated therewith; and if TCI=2, using an uplink resource and uplink beam information (configured grant) corresponding to SSB index=2 and the 2nd CG setting information. Note that a plurality of TCIs may be associated with one piece of CG setting information. In this case, for example, the terminal apparatus 200 can be instructed such that when receiving TCI=1 or TCI=2, it uses an uplink resource and uplink beam information (configured grant) corresponding to SSB index=1 and the 1st CG setting information (CG Occasion) associated therewith, and when receiving TCI=3 or TCI=4, it uses an uplink resource and uplink beam information (configured grant) corresponding to SSB index=2 and the 2nd CG setting information associated therewith. Thereby, CG setting information (CG Occasion) set in the terminal apparatus 200 can be reduced, and uplink wireless resources allocated to each terminal apparatus can be saved when the congestion degree is high or the like.

### (iv) Step S404

The RA instruction unit 1012_1 of the handover source base station apparatus 100_1 transmits a PDCCH order to the terminal apparatus 200, and instructs the terminal apparatus 200 to transmit an RA preamble to the handover destination base station apparatus 100_2 (designating an appropriate candidate cell base station apparatus if there are a plurality of candidate cells). Here, this instruction (PDCCH order) can include a sequence to be used by the terminal apparatus 200 for generation of the RA preamble and information designating a wireless resource on which the RA preamble is to be transmitted. Note that the wireless resource on which the RA preamble is to be transmitted may be specified based on, for example, system information in the handover destination base station apparatus 100_2 transmitted from the handover destination base station apparatus 100_2 and measured by the terminal apparatus 200. That is, this information does not need to be obtained from the connected handover source base station apparatus 100_1. Also, the sequence to be used when generating the RA preamble may be specified in advance. In one example, in step S403, information of this sequence may be notified to the terminal apparatus 200.

### (v) Step S405

The RA execution unit 2012 of the terminal apparatus 200 transmits an RA preamble to the handover destination base station apparatus 100_2 according to the instruction. The execution of the RA procedure is for suppressing deterioration of communication efficiency in handover. When the RA preamble is transmitted, the inter-base station communication unit 1014_1 of the handover source base station apparatus 100_1 may notify the handover destination base station apparatus 100_2 that the terminal apparatus 200 is scheduled to transmit the RA preamble. At this time, the inter-base station communication unit 1014_1 of the handover source base station apparatus 100_1 can notify the handover destination base station apparatus 100_2 of information of the sequence used by the terminal apparatus 200 for generation of the RA preamble. Thereby, the RA instruction unit 1012_2 of the handover destination base station apparatus 100_2 becomes able to detect the RA preamble transmitted by the terminal apparatus 200. Note that this processing is an example, and it may be notified implicitly that the terminal apparatus 200 is scheduled to transmit the RA preamble by the HANDOVER REQUEST in step S401. Also, in this case, in the HANDOVER REQUEST ACK of step S402, the sequence to be used by the terminal apparatus 200 for generation of the RA preamble may be designated by the handover destination base station apparatus 100_2. Note that these are examples, and information of the sequence to be used by the terminal apparatus 200 for generation of the RA preamble etc. may be shared between the handover source base station apparatus 100_1 and the handover destination base station apparatus 100_2 using other messages.

### (vi) Step S406

The TA maintenance management unit 1015_2 of the handover destination base station apparatus 100_2 calculates a TA value based on the RA preamble transmitted from the terminal apparatus 200. Then, the inter-base station communication unit 1014_2 notifies the handover source base station apparatus 100_1 of the calculated TA value. Note that this TA value may be managed by both the handover source base station apparatus 100_1 and the handover destination base station apparatus 100_2, or may be managed by one of them. This TA value may be obtained from the handover destination base station apparatus 100_2, for example, in response to the handover source base station apparatus 100_1 deciding execution of handover of the terminal apparatus 200. For example, the inter-base station communication unit 1014_1 of the handover source base station apparatus 100_1 notifies the handover destination base station apparatus 100_2 of execution of handover. As a response to the notification, the TA maintenance management unit 1015_1 obtains the TA value from the handover destination base station apparatus 100_2. Note that when there are a plurality of handover destination (candidate) base station apparatuses (handover destination base station apparatuses 100_2 to 100_k), the handover source base station apparatus 100_1 may obtain TA values from all handover destination (candidate) base station apparatuses.

Note that at this point, the terminal apparatus 200 has not yet started handover to the handover destination base station apparatus 100_2. In this state, the handover processing unit 2013 of the terminal apparatus 200 continuously executes measurement of wireless signals (for example, SSB measurement) from the handover destination base station apparatus 100_2, and notifies the connected handover source base station apparatus 100_1 of the measurement result. The handover instruction unit 1013 of the handover source base station apparatus 100_1 can decide that handover should be performed according to this measurement result.

### (vii) Step S407

The handover instruction unit 1013_1 of the handover source base station apparatus 100_1 notifies the terminal apparatus 200 of the TA value obtained from the handover destination base station apparatus 100_2, and transmits an uplink reference signal (SRS) transmission instruction. Note that when there are a plurality of handover destination (candidate) base station apparatuses (handover destination base station apparatuses 100_2 to 100_k), the handover source base station apparatus 100_1 notifies the terminal apparatus 200 of TA values of all handover destination (candidate) base station apparatuses. Note that the notification of the TA value and the uplink reference signal (SRS) transmission instruction can be notified to the terminal apparatus 200 at different timings.

### (viii) Step S408

The handover processing unit 2013 of the terminal apparatus 200 transmits an uplink reference signal (SRS) to the handover destination base station apparatus 100_2.

The uplink beam information determination unit 1017_2 of the handover destination base station apparatus 100_2 determines (specifies) an uplink beam (UL Beam) to be used when the terminal apparatus 200 communicates with the handover destination base station apparatus 100_2 by measuring the SRS transmitted by the terminal apparatus 200.

### (ix) Step S409

The uplink beam information determination unit 1017_2 of the handover destination base station apparatus 100_2 designates uplink beam information to be used by the terminal apparatus 200 by a TCI (Transmission Configuration Indicator). Then, the inter-base station communication unit 1014_2 of the handover destination base station apparatus 100_2 provides the TCI to the handover source base station apparatus 100_1.

### (x) Step S410

The handover instruction unit 1013 of the handover source base station apparatus 100_1 notifies the terminal apparatus 200 of the TCI obtained from the handover destination base station apparatus 100_2 using, for example, a Medium Access Control - Control Element (MAC CE) or Downlink Control Information (DCI).

### (xi) Step S411

The handover instruction unit 1013_1 of the handover source base station apparatus 100_1 transmits a Cell Switch Command to the terminal apparatus 200. The Cell Switch Command can be transmitted using, for example, a Medium Access Control - Control Element (MAC CE) or Downlink Control Information (DCI).

When the handover processing unit 2013 of the terminal apparatus 200 has successfully received the Cell Switch Command, a resource for PUSCH is allocated by the handover destination base station apparatus 100_2, and the handover is completed. Then, the terminal apparatus 200 becomes able to transmit user data to the handover destination base station apparatus 100_2 using the allocated resource for PUSCH. Note that the terminal apparatus 200 has already executed the RA procedure as described above. For this reason, when the terminal apparatus 200 has successfully received the Cell Switch Command, it is not necessary to execute the RA procedure again, and it can immediately transmit user data to the handover destination base station apparatus 100_2 using the designated wireless resource.

Also, when the Cell Switch Command has been successfully received, the handover processing unit 2013 of the terminal apparatus 200 may transmit an acknowledgement (Ack) or the like to the handover source base station apparatus 100_1. Furthermore, when the Cell Switch Command is received, the handover processing unit 2013 switches the connection destination to the handover destination base station apparatus 100_2, and may transmit Ack, RRCReconfigurationComplete, or the like to the handover destination base station apparatus 100_2 using the allocated uplink wireless resource. Then, the inter-base station communication unit 1014 of the handover destination base station apparatus 100_2 can transfer the acknowledgement to the handover source base station apparatus 100_1. Thereby, the handover source base station apparatus 100_1 can recognize that the terminal apparatus 200 has switched the connection destination to the handover destination base station apparatus 100_2, and for example, can discard context information of the terminal apparatus 200.

On the other hand, when the Ack from the terminal apparatus 200 is not received, the handover instruction unit 1013_1 of the handover source base station apparatus 100_1 may retransmit the Cell Switch Command so that the handover is reliably performed.

### (xii) Step S412

The LTM execution condition determination unit 2015 of the terminal apparatus 200 determines (confirms) existence or non-existence of a match (satisfaction) of the above condition of LTM execution. Specifically, the LTM execution condition determination unit 2015 determines whether the condition of LTM execution corresponding to each LTM transition destination candidate cell notified from the handover source base station apparatus 100_1 is satisfied.

### (xiii) Step S413

When the LTM execution condition determination unit 2015 of the terminal apparatus 200 confirms the match of the condition of LTM execution, the handover processing unit 2013 decides execution of processing for cell switching to the handover destination base station apparatus 100_k of the candidate cell corresponding to the condition match. Note that when there are a plurality of candidate cells matching the condition of LTM execution, for example, a candidate cell with the shortest distance between the terminal apparatus 200 and each handover destination base station apparatus 100_k may be selected as a switching destination, or a candidate cell with the lowest congestion degree may be selected as a switching destination.

### (xiv) Step S414

When a match of the condition of LTM execution is confirmed, the timer control unit 2016 of the terminal apparatus 200 activates a timer (T304).

### (xv) Step S415

At a timing based on the TA value, the handover processing unit 2013 of the terminal apparatus 200 specifies a configured grant to be used for uplink transmission based on the uplink beam (UL Beam) designated by the TCI and the UL Beam information table, and transmits uplink data, for example, RRCReconfiguration Complete, to the handover destination base station apparatus 100_2 using an uplink beam (UL Beam) designated by the TCI using a resource (PUSCH) of an uplink shared channel corresponding to the specified configured grant.

### (xvi) Step S416

The handover destination base station apparatus 100_2 which received RRCReconfigurationComplete transmits UE Contention Resolution Identity MAC CE or C-RNTI addressing PDCCH to the terminal apparatus 200 using the PUCCH/PDCCH communication unit 1016_2.

### (xvii) Step S417

Upon receiving UE Contention Resolution Identity MAC CE or C-RNTI addressing PDCCH, the timer control unit 2016 of the terminal apparatus 200 stops the timer (T304) activated in step S414.

Note that after cell switching, the terminal apparatus 200 may hold information condLTMReconfig regarding cell switching processing that was not executed. By holding information regarding cell switching processing that was not executed even after cell switching, the terminal apparatus 200 can make it unnecessary to newly receive condLTMReconfig from the base station apparatus after cell switching. Also, information regarding whether or not to hold the information condLTMReconfig regarding cell switching processing that was not executed may be notified from the handover source base station apparatus 100_1 before cell switching to the terminal apparatus 200.

As described above, it is possible to shorten a period during which communication of user data cannot be performed (instantaneous interruption time) when the terminal apparatus 200 performs handover from the handover source base station apparatus 100_1 to the handover destination base station apparatus 100_2. Also, since it is not necessary to transmit an RA preamble to the handover destination base station apparatus 100_2 again when executing LTM, and uplink data can be transmitted using the TA value, the designated uplink beam, and the configured grant, processing speed can be increased compared to the case of transmitting an RA preamble. Thereby, for example, provision of communication services requiring low latency and high reliability becomes possible. Also, by shortening the period during which communication of user data cannot be performed (instantaneous interruption time), it becomes possible to suppress a decrease in efficiency of wireless communication.

### Handover Processing Sequence Example 2

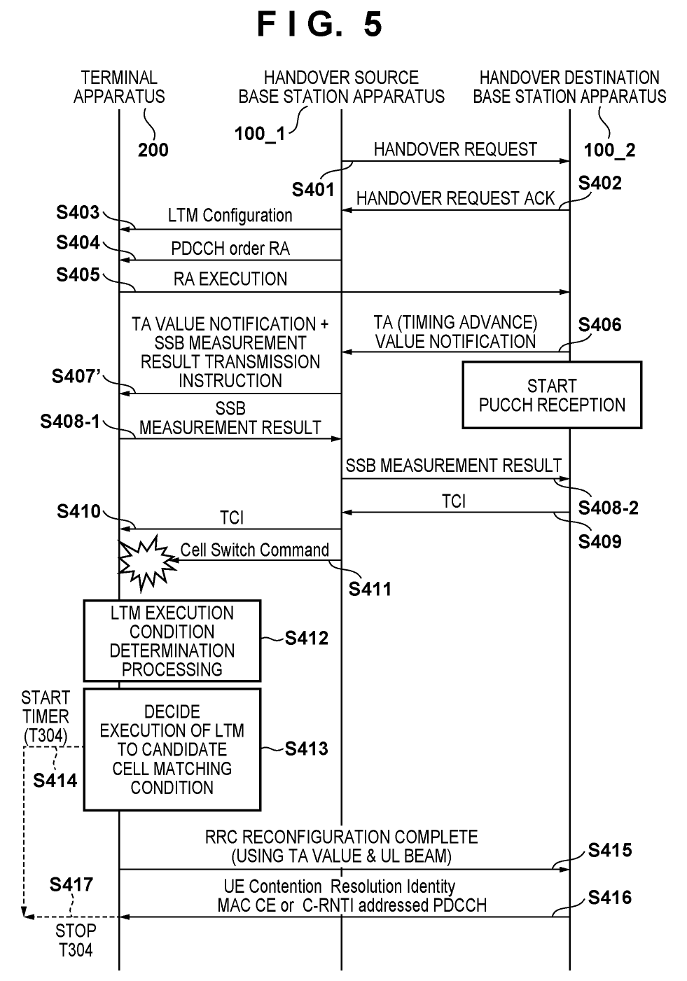

FIG. 5 is a diagram for explaining a sequence example 2 of handover processing according to the present embodiment. Also in the sequence example 2 of FIG. 5, it is assumed that a connection is established between the handover source base station apparatus 100_1 and the terminal apparatus 200. Also in the sequence example 2 of FIG. 5, similarly to FIG. 4, only the handover destination base station apparatus 100_2 is shown as a base station apparatus of an LTM transition destination candidate cell, but in reality, there exist handover destination base station apparatuses 100_k of a plurality of LTM transition destination candidate cells.

In the sequence example 2 of FIG. 5, a portion of steps S407 and 409 is changed from the sequence example 1 of FIG. 4 to be steps S407' and S409', and step S408 is changed to step S408-1 and step S408-2; however, since other steps are similar to the sequence example 1 of FIG. 4, description is omitted.

### (i) Step S407'

The handover instruction unit 1013_1 of the handover source base station apparatus 100_1 notifies the terminal apparatus 200 of the TA value obtained from the handover destination base station apparatus 100_2, and transmits a downlink reference signal (for example, SSB or CSI-RS) measurement result transmission instruction (does not send an uplink reference signal (SRS) transmission instruction). Note that when there are a plurality of handover destination (candidate) base station apparatuses (handover destination base station apparatuses 100_2 to 100_k), the handover source base station apparatus 100_1 notifies the terminal apparatus 200 of TA values of all handover destination (candidate) base station apparatuses.

### (ii) Step S408-1

The base station apparatus 100_k of each LTM transition destination candidate cell continuously outputs a downlink reference signal (for example, SSB or CSI-RS) at a constant cycle. The handover processing unit 2013 of the terminal apparatus 200 measures each downlink reference signal (SRS) and transmits the measurement result to the handover source base station apparatus 100_1.

### (iii) Step S408-2

The inter-base station communication unit 1014_1 of the handover source base station apparatus 100_1 transmits the downlink reference signal (SSB or CSI-RS) measurement result obtained from the terminal apparatus 200 to the handover destination base station apparatus 100_2.

The uplink beam information determination unit 1017_2 of the handover destination base station apparatus 100_2 determines (specifies) an uplink beam (UL Beam) to be used when the terminal apparatus 200 communicates with the handover destination base station apparatus 100_2 based on the downlink reference signal measurement result by the terminal apparatus 200 (downlink beam information and uplink beam information are paired (due to duality), and if a downlink beam can be specified, an uplink beam can be specified).

### Handover Processing Sequence Example 3

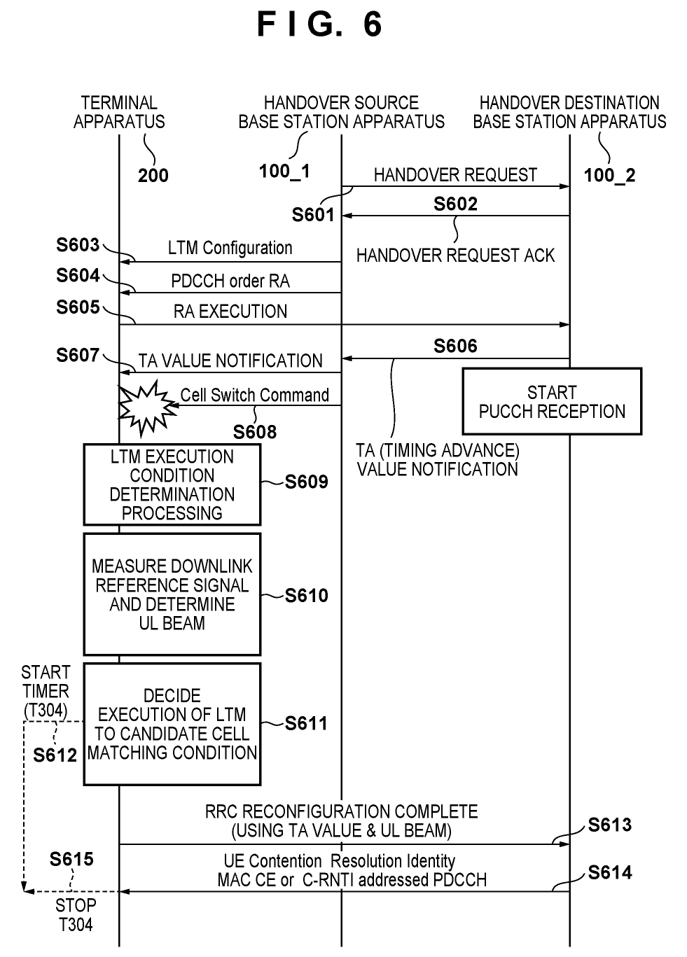

FIG. 6 is a diagram for explaining a sequence example 3 of handover processing according to the present embodiment. Also in the example of FIG. 6, similarly to FIG. 4, it is assumed that a connection is established between the handover source base station apparatus 100_1 and the terminal apparatus 200. Also in FIG. 6, only the handover destination base station apparatus 100_2 is shown as a base station apparatus of an LTM transition destination candidate cell, but in reality, there exist handover destination base station apparatuses 100_k of a plurality of LTM transition destination candidate cells.

### (i) Step S601 to Step S606

The processing from step S601 to step S606 is the same as step S401 to step S406 of FIG. 4.

### (ii) Step S607

The handover instruction unit 1013_1 of the handover source base station apparatus 100_1 notifies the terminal apparatus 200 of the TA value obtained from the handover destination base station apparatus 100_2 (unlike step S407, does not transmit an uplink reference signal (SRS) transmission instruction). Note that when there are a plurality of handover destination (candidate) base station apparatuses (handover destination base station apparatuses 100_2 to 100_k), the handover source base station apparatus 100_1 notifies the terminal apparatus 200 of TA values of all handover destination (candidate) base station apparatuses.

### (iii) Step S608

The handover instruction unit 1013_1 of the handover source base station apparatus 100_1 transmits a Cell Switch Command to the terminal apparatus 200. The Cell Switch Command can be transmitted using, for example, a Medium Access Control - Control Element (MAC CE) or Downlink Control Information (DCI).

### (iv) Step S609

The processing of step S609 is the same as step S412 of FIG. 4.

### (v) Step S610

The reference signal measurement/notification unit 2014 of the terminal apparatus 200 detects/measures downlink reference signals (SSB or CSI-RS) output from each handover destination base station apparatus 100_k, and selects a reference signal with the best communication quality or a reference signal found first (a signal of predetermined quality (threshold) or higher). Then, the reference signal measurement/notification unit 2014 determines a configured grant (uplink resource and uplink beam information) corresponding to an index of the selected downlink reference signal (SSB) based on the information (UL Beam information table) obtained in the above LTM Configuration.

### (vi) Step S611

When the reference signal measurement/notification unit 2014 of the terminal apparatus 200 determines the configured grant, the handover processing unit 2013 decides execution of cell switching processing to the handover destination base station apparatus 100_k of the candidate cell corresponding to the condition match. Note that when there are a plurality of candidate cells matching the condition of LTM execution, for example, a candidate cell for which the distance between the terminal apparatus 200 and the respective handover destination base station apparatus 100_k is shortest may be selected as a switching destination, or a candidate cell with the lowest congestion degree may be selected as a switching destination.

### (xii) Step S612 to Step S615

The processing from step S612 to step S615 is the same as step S414 to step S417 of FIG. 4.

### Summary of Embodiments

### (i) Terminal Apparatus According to a First Embodiment

A terminal apparatus that has a conditional LTM function and performs communication with a plurality of base station apparatuses while switching a connection destination, comprising:

a storage device that holds a program related to handover; and

a processor that reads the program from the storage device and executes handover processing,

wherein the processor executes:

processing of obtaining, from a connected handover source base station apparatus, first information associating a configured grant regarding a resource of an uplink shared channel of an LTM candidate cell with an uplink beam setting, and information of a condition of LTM execution associated with a handover destination base station apparatus of the LTM candidate cell;

processing of transmitting an uplink reference signal to the handover destination base station apparatus of the LTM candidate cell in response to an uplink reference signal transmission instruction from the handover source base station apparatus;

processing of obtaining, from the handover source base station apparatus, second information regarding an uplink beam to be used by the terminal apparatus determined by the handover destination base station apparatus of the LTM candidate cell based on a measurement result of the uplink reference signal;

processing of determining whether the condition of LTM execution associated with the base station apparatus of the handover destination candidate is satisfied;

processing of specifying, when the condition of LTM execution is satisfied, a configured grant to be used for uplink transmission based on the first information and the second information at the time of LTM execution, without starting a random access procedure; and

processing of performing uplink transmission to the base station apparatus of the handover destination candidate using the configured grant to be used for the uplink transmission.

### (ii) Terminal Apparatus According to a Second Embodiment

A terminal apparatus that has a conditional LTM function and performs communication with a plurality of base station apparatuses while switching a connection destination, comprising:

a storage device that holds a program related to handover; and

a processor that reads the program from the storage device and executes handover processing,

wherein the processor executes:

processing of obtaining, from a connected handover source base station apparatus, first information associating a configured grant regarding a resource of an uplink shared channel of an LTM candidate cell with an uplink beam setting, and information of a condition of LTM execution associated with a handover destination base station apparatus of the LTM candidate cell;

processing of notifying the handover source base station apparatus of a measurement result of a downlink reference signal from the LTM candidate cell;

processing of obtaining, from the handover source base station apparatus, second information regarding an uplink beam to be used by the terminal apparatus determined by the handover destination base station apparatus of the LTM candidate cell;

processing of determining whether the condition of LTM execution associated with the base station apparatus of the handover destination candidate is satisfied;

processing of specifying, when the condition of LTM execution is satisfied, a configured grant to be used for uplink transmission based on the first information and the second information at the time of LTM execution, without starting a random access procedure; and

processing of performing uplink transmission to the base station apparatus of the handover destination candidate using the configured grant to be used for the uplink transmission.

### (iii) Terminal Apparatus According to a Third Embodiment

A terminal apparatus that has a conditional LTM function and performs communication with a plurality of base station apparatuses while switching a connection destination, comprising:

a storage device that holds a program related to handover; and

a processor that reads the program from the storage device and executes handover processing,

wherein the processor executes:

processing of obtaining, from a connected handover source base station apparatus, beam setting related information associating a downlink reference signal of an LTM candidate cell with a configured grant regarding a resource of an uplink shared channel, and information of a condition of LTM execution associated with a handover destination base station apparatus of the LTM candidate cell;

processing of determining whether the condition of LTM execution associated with the base station apparatus of the handover destination candidate is satisfied;

processing of specifying, when the condition of LTM execution is satisfied, a configured grant regarding a resource of the uplink shared channel to be used in the handover destination base station apparatus of the LTM candidate cell using a measurement result of the downlink reference signal of the LTM candidate cell and the beam setting related information; and

processing of performing uplink transmission to the base station apparatus of the handover destination candidate using the configured grant regarding the resource of the uplink shared channel at the time of LTM execution, without starting a random access procedure.

In the above-described embodiment, description was made assuming that the handover source and handover destination base station apparatuses provide one cell, but these base station apparatuses may provide a plurality of cells. Also, in the above description, the term "base station apparatus" may be read as "cell". That is, in the above description, terms such as "handover source base station apparatus" are used, but these may be read as "handover source cell". However, it should be noted that the entity performing transmission and reception of signals is the base station apparatus providing each cell. Also, in the above example, an example in which the terminal apparatus transmits an SRS has been described, but another uplink reference signal different from the SRS may be used for determination of the uplink beam used by the terminal apparatus.

(iv) The functions of the present embodiment and each example can also be realized by software program code. In this case, a storage medium recording the program code is provided to a system or an apparatus, and a computer (or CPU or MPU) of the system or the apparatus reads the program code stored in the storage medium. In this case, the program code itself read from the storage medium realizes the functions of the aforementioned embodiment, and the program code itself and the storage medium storing it constitute the present disclosure. As a storage medium for supplying such program code, for example, a flexible disk, CD-ROM, DVD-ROM, hard disk, optical disk, magneto-optical disk, CD-R, magnetic tape, non-volatile memory card, ROM, etc. are used.

Also, based on instructions of the program code, an OS (Operating System) or the like running on the computer may perform a part or all of actual processing, and the functions of the aforementioned embodiment may be realized by that processing. Furthermore, after the program code read from the storage medium is written into a memory on the computer, a CPU or the like of the computer may perform a part or all of actual processing based on instructions of the program code, and the functions of the aforementioned embodiment may be realized by that processing.

Furthermore, by distributing the software program code realizing the functions of the embodiment and each example via a network, it may be stored in storage means such as a hard disk or memory of a system or an apparatus or a storage medium such as a CD-RW or CD-R, and a computer (or CPU or MPU) of the system or the apparatus may read and execute the program code stored in the storage means or the storage medium at the time of use.

The processes and technologies described herein are not essentially related to any specific apparatus, and can also be implemented by a combination of respective components. Also, diverse types of general-purpose devices can be added. Dedicated apparatuses may be constructed to execute the functions of the present embodiment and each example. Also, various functions can be formed by appropriately combining a plurality of constituent elements disclosed in the present embodiment and each example. For example, some constituent elements may be deleted from all constituent elements shown in the embodiment and each example, or constituent elements across different examples may be combined as appropriate.

In the present disclosure, specific examples are described, but these are for explanation (understanding of the technology of the present disclosure) and not for limitation in all aspects. A person having ordinary knowledge in the present technical field will understand that there are numerous combinations of hardware, software, and firmware suitable for implementing the technology of the present disclosure. For example, the described software can be implemented in a wide range of programs or script languages such as Assembler, C/C++, perl, Shell, PHP, Java (registered trademark).

Furthermore, in the above-described embodiment, control lines and information lines are those considered necessary for explanation, and do not necessarily show all control lines and information lines on a product. All configurations may be mutually connected.

In addition, those having ordinary knowledge in this technical field can clarify other implementations of the present disclosure based on consideration of the present embodiment and each example. The specification and specific examples are merely typical ones, and the scope and spirit of the technology of the present disclosure are indicated by the following claims.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

According to the technology of the present disclosure, even when a terminal apparatus cannot receive a Cell Switch command, handover processing can be executed, and speeding up of processing and shortening of instantaneous interruption time can be realized.

What is claimed is:

1. A terminal apparatus that has an L1L2 Triggered Mobility (LTM) function and performs communication with a plurality of base station apparatuses while switching a connection destination, comprising
a storage device that holds a program related to handover; and
a processor that reads the program from the storage device and executes handover processing,
wherein the processor executes:
obtaining, from a connected handover source base station apparatus, first information associating a configured grant regarding a resource of an uplink shared channel of an LTM candidate cell with an uplink beam setting, and information of a condition of LTM execution associated with a handover destination base station apparatus of the LTM candidate cell;
transmitting an uplink reference signal to the handover destination base station apparatus of the LTM candidate cell in response to an uplink reference signal transmission instruction from the handover source base station apparatus;
obtaining, from the handover source base station apparatus, second information regarding an uplink beam to be used by the terminal apparatus determined by the handover destination base station apparatus of the LTM candidate cell based on a measurement result of the uplink reference signal;
determining whether the condition of LTM execution associated with the base station apparatus of the handover destination candidate is satisfied;
specifying, when the condition of LTM execution is satisfied, a configured grant to be used for uplink transmission based on the first information and the second information at the time of LTM execution, without starting a random access procedure; and
performing uplink transmission to the base station apparatus of the handover destination candidate using the configured grant to be used for the uplink transmission.

2. The terminal apparatus according to claim 1, wherein the processor executes processing of obtaining a timing advance value of the handover destination base station apparatus of the LTM candidate cell from the handover source base station apparatus before LTM execution.

3. The terminal apparatus according to claim 2, wherein the processor executes processing of determining a timing for performing the uplink transmission to the handover destination base station apparatus using the timing advance value.

4. The terminal apparatus according to claim 3, wherein the processor transmits RRCReconfiguration Complete to the base station apparatus of the handover destination candidate using the configured grant to be used for the uplink transmission at the determined timing.

5. A terminal apparatus that has an L1L2 Triggered Mobility (LTM) function and performs communication with a plurality of base station apparatuses while switching a connection destination, comprising
a storage device that holds a program related to handover; and
a processor that reads the program from the storage device and executes handover processing,
wherein the processor executes:
obtaining, from a connected handover source base station apparatus, first information associating a configured grant regarding a resource of an uplink shared channel of an LTM candidate cell with an uplink beam setting, and information of a condition of LTM execution associated with a handover destination base station apparatus of the LTM candidate cell;
notifying the handover source base station apparatus of a measurement result of a downlink reference signal from the LTM candidate cell;
obtaining, from the handover source base station apparatus, second information regarding an uplink beam to be used by the terminal apparatus determined by the handover destination base station apparatus of the LTM candidate cell;
determining whether the condition of LTM execution associated with the base station apparatus of the handover destination candidate is satisfied;
specifying, when the condition of LTM execution is satisfied, a configured grant to be used for uplink transmission based on the first information and the second information at the time of LTM execution, without starting a random access procedure; and
performing uplink transmission to the base station apparatus of the handover destination candidate using the configured grant to be used for the uplink transmission.

6. The terminal apparatus according to claim 5, wherein the processor executes processing of obtaining a timing advance value of the handover destination base station apparatus of the LTM candidate cell from the handover source base station apparatus before LTM execution.

7. The terminal apparatus according to claim 6, wherein the processor executes processing of determining a timing for performing the uplink transmission to the handover destination base station apparatus using the timing advance value.

8. The terminal apparatus according to claim 7, wherein the processor transmits RRCReconfiguration Complete to the base station apparatus of the handover destination candidate using the configured grant to be used for the uplink transmission at the determined timing.

9. A terminal apparatus that has a conditional L1L2 Triggered Mobility (LTM) function and performs communication with a plurality of base station apparatuses while switching a connection destination, comprising
a storage device that holds a program related to handover; and
a processor that reads the program from the storage device and executes handover processing,
wherein the processor executes:
obtaining, from a connected handover source base station apparatus, beam setting related information associating a downlink reference signal of an LTM candidate cell with a configured grant regarding a resource of an uplink shared channel, and information of a condition of LTM execution associated with a handover destination base station apparatus of the LTM candidate cell;
determining whether the condition of LTM execution associated with the base station apparatus of the handover destination candidate is satisfied;
specifying, when the condition of LTM execution is satisfied, a configured grant regarding a resource of the uplink shared channel to be used in the handover destination base station apparatus of the LTM candidate cell using a measurement result of the downlink reference signal of the LTM candidate cell and the beam setting related information; and
performing uplink transmission to the base station apparatus of the handover destination candidate using the configured grant regarding the resource of the uplink shared channel at the time of LTM execution, without starting a random access procedure.

10. The terminal apparatus according to claim 9, wherein the processor executes, when a radio link failure is detected, processing of specifying the configured grant regarding the resource of the uplink shared channel using the measurement result of the downlink reference signal and the beam setting related information, and
processing of performing uplink transmission to the base station apparatus of the handover destination candidate using the configured grant regarding the resource of the uplink shared channel without starting a random access procedure at the time of LTM execution.

11. The terminal apparatus according to claim 9, wherein the downlink reference signal is SSB or CSI-RS.

12. The terminal apparatus according to claim 9, wherein the beam setting related information is information associating the downlink reference signals of a plurality of the LTM candidate cell with configured grants regarding resources of a plurality of the uplink shared channel, and
the processor holds the beam setting related information in the storage device by associating a plurality of downlink reference signals with one configured grant.

13. The terminal apparatus according to claim 9, wherein the processor executes processing of obtaining a timing advance value of the handover destination base station apparatus of the LTM candidate cell from the handover source base station apparatus before LTM execution.

14. The terminal apparatus according to claim 13, wherein the processor executes processing of determining a timing for performing the uplink transmission to the handover destination base station apparatus using the timing advance value.

15. The terminal apparatus according to claim 14, wherein the processor transmits RRCReconfiguration Complete to the base station apparatus of the handover destination candidate using the configured grant regarding the resource of the uplink shared channel at the determined timing.

16. A wireless communication system that comprises a plurality of base station apparatuses and at least one terminal apparatus having an L1L2 Triggered Mobility (LTM) function, and executes a handover from a handover source base station apparatus to a base station apparatus of a handover destination candidate, wherein
the handover source base station apparatus to which the terminal apparatus is connected executes:
transmitting, to the terminal apparatus, first information associating a configured grant regarding a resource of an uplink shared channel of an LTM candidate cell with an uplink beam setting, and information of a condition of LTM execution associated with a handover destination base station apparatus of the LTM candidate cell;
transmitting an uplink reference signal transmission instruction to the terminal apparatus; and
transmitting, to the terminal apparatus, second information regarding an uplink beam to be used by the terminal apparatus; and
the terminal apparatus executes:
transmitting an uplink reference signal to the handover destination base station apparatus of the LTM candidate cell in response to the uplink reference signal transmission instruction from the handover source base station apparatus;
obtaining, from the handover source base station apparatus, the second information determined by the handover destination base station apparatus of the LTM candidate cell based on a measurement result of the uplink reference signal;
determining whether the condition of LTM execution associated with the base station apparatus of the handover destination candidate is satisfied;
specifying, when the condition of LTM execution is satisfied, a configured grant to be used for uplink transmission based on the first information and the second information at the time of LTM execution, without starting a random access procedure; and
performing uplink transmission to the base station apparatus of the handover destination candidate using the configured grant to be used for the uplink transmission.

17. A wireless communication system that comprises a plurality of base station apparatuses and at least one terminal apparatus having an L1L2 Triggered Mobility (LTM) function, and executes a handover from a handover source base station apparatus to a base station apparatus of a handover destination candidate, wherein
the handover source base station apparatus to which the terminal apparatus is connected executes:
transmitting, to the terminal apparatus, first information associating a configured grant regarding a resource of an uplink shared channel of an LTM candidate cell with an uplink beam setting, and information of a condition of LTM execution associated with a handover destination base station apparatus of the LTM candidate cell; and
transmitting, to the terminal apparatus, second information regarding an uplink beam to be used by the terminal apparatus determined by the handover destination base station apparatus of the LTM candidate cell; and
the terminal apparatus executes:
notifying the handover source base station apparatus of a measurement result of a downlink reference signal from the LTM candidate cell;
determining whether the condition of LTM execution associated with the base station apparatus of the handover destination candidate is satisfied;
specifying, when the condition of LTM execution is satisfied, a configured grant to be used for uplink transmission based on the first information and the second information at the time of LTM execution, without starting a random access procedure; and
performing uplink transmission to the base station apparatus of the handover destination candidate using the configured grant to be used for the uplink transmission.

18. A wireless communication system that comprises a plurality of base station apparatuses and at least one terminal apparatus having an L1L2 Triggered Mobility (LTM) function, and executes a handover from a handover source base station apparatus to a base station apparatus of a handover destination candidate, comprising
the handover source base station apparatus to which the terminal apparatus is connected
executes transmitting, to the terminal apparatus, beam setting related information associating a downlink reference signal of an LTM candidate cell with a configured grant regarding a resource of an uplink shared channel, and information of a condition of LTM execution associated with a handover destination base station apparatus of the LTM candidate cell; and
the terminal apparatus executes:
determining whether the condition of LTM execution associated with the base station apparatus of the handover destination candidate is satisfied;
specifying, when the condition of LTM execution is satisfied, a configured grant regarding a resource of the uplink shared channel to be used in the handover destination base station apparatus of the LTM candidate cell using a measurement result of the downlink reference signal of the LTM candidate cell and the beam setting related information; and
performing uplink transmission to the base station apparatus of the handover destination candidate using the configured grant regarding the resource of the uplink shared channel at the time of LTM execution, without starting a random access procedure.
